(19) United States
(12) Patent Application Publication
(10) Pub. No.: US 2004/0099644 A1
(43) Pub. Date: May 27, 2004

(54) System and method for post weld conditioning

(76) Inventor: John R. Allen, Houston, TX (US)

Correspondence Address: KENNETH L. NASH, P.O. BOX 680106, HOUSTON, TX, 77268-0106, US

(21) Appl. No.: 10/676,235

(22) Filed: Oct. 1, 2003

Related U.S. Application Data
(60) Provisional application No. 60/419,345, filed on Oct. 18, 2002.

(51) Int. Cl. B23K 31/02

(52) U.S. Cl. 219/121.64

(57) ABSTRACT

The present invention provides a system and method for conditioning the surface and subsurface of a tubular whereby stress risers and crevices are avoided during subsequent working of the tubular. In a preferred embodiment, the invention may be readily utilized to modify a continuous tubular manufacturing operation wherein a laser beam welder is utilized for welding the seam of the tubular as the tubular is moved with respect to the laser beam welder thereby producing an elongate bead. A TIG welder is provided downstream of the laser beam welder with respect to the direction of movement of the tubular to thereby remelt the crown portion of the elongate bead thereby causing the crown portion to flatten radially and spread out along the surface of the tubular. Because the forces produced by working the hard weld nugget are spread over a wider area, the conditioned weld may now be worked into the wall of the tubular utilizing standard working techniques without loss of tubular wall diameter or producing folded over portions that are more susceptible to metal fatigue.

This application claims priority of U.S. Provisional Application No. 60/419,345 filed Oct. 18, 2002.

### TECHNICAL FIELD

The present invention relates generally to high energy welding, and more particularly to methods and apparatus for conditioning the work piece weld surface and subsurface.

### BACKGROUND ART

Tubulars such as pipes for high-pressure service, well casings, structural beams, and for many other purposes may be formed by rolling/pulling techniques to thereby work the metal into a pipe. During the creation of such pipes, welding is utilized to weld the seam to seal the rolled pipe. During a continuous tube and pipe manufacturing process, it is desirable to weld the seam utilizing welding techniques that produce a weld that is narrow with respect to the depth of penetration of the weld. Laser beam welding is often utilized for this purpose.

Laser welds for this purpose may be designed utilizing keyholing techniques to provide a weld about 0.015-0.020 inches wide, but easily penetrating beyond 0.25 inches. One quality of laser welds is the low thermal input required to join two pieces of metal, resulting in a small but precise weld nugget. The weld nugget “freezes” exceptionally quickly once the laser energy is removed, or as the work piece is removed from the laser beam when the workpiece moves down an assembly line such as may occur in a continuous tubular manufacturing process. The resulting weld is usually harder and/or has a higher strength structure in the weld zone than in the base or surrounding metal.

While the metal is fluid during the weld, a small amount of metal flows out of the seam and forms a hard weld crown on the outer surface of the tubular as part of the weld nugget. The crown is often of a microscopic size. For instance, in a keyhole method of laser welding used to obtain deep welds, the weld crown or bead is typically about the same height above the surface of the base metal as the weld is wide.

Although this weld geometry may not be detrimental to the weld itself, the subsequent handling of the weld and its surface conditioning, such as subsequent round tooling or rolling of the tubular member for shaping purposes may result in increasing the likelihood of failure of the tubular. The pressures exerted on the member walls and adjoining weld, such as in the sizing process wherein the member walls are plastically deformed, may accentuate the problems associated with a hard weld bead. Thus, if this hard weld crown is not removed or conditioned, then serious problems may arise relating to reliability of the tubular. Moreover, microscopic voids may be produced where bacteria, dirt, oil, and grease may be trapped making the pipe difficult to clean with subsequent surface finishing processes. Another potential problem is the creation of stress risers that run parallel and along both sides of the weld crown.

Therefore, the crown is frequently removed by various means such as hammering, precision grinding, scraping, abrasives, cutting tools, or the like. However, these methods can produce additional stress risers or other surface or subsurface imperfections because of a tool breakdown or improper adjustment. Due to the wear that occurs to the abrasive or cutting tools, much attention and subsequent adjustments are required during a continuous tubular manufacturing process thereby increasing the costs. In addition, these bead removal methods may also remove some of the base tube material and consequently reduce the mechanical properties and effective wall thickness of the finished product. These types of flaws may be especially detrimental to pressure critical applications such as pressure vessels. Furthermore, health hazards are often associated with the particles so produced.

The article “Inspecting Welds to Improve Fatigue Life,” by T. Anderson, from Practical Welding Today, May/June 2002, p. 44-5, discusses the problems of welding discontinuities and stress concentrations that lead to fatigue failure.

The ASM Handbook, Volume 11, entitled “Failure Analysis and Prevention,” March 1998, p.448, discloses how discontinuities arise when utilizing high-frequency induction welds of tubulars that may cause cracks to develop.

The above cited prior art does not provide a suitable means for removing the hard crown or bead formed during welding of the seam while forming tubulars. Consequently, there has been a long felt but unsolved need to provide improved surface conditioning apparatus and methods that result in higher quality goods while simultaneously lowering manufacturing costs. Those of skill in the art will appreciate the present invention which addresses the above problems and other problems.

### SUMMARY OF THE INVENTION

Accordingly, it is an objective of the present invention to provide an improved post weld conditioning system and method.

Another objective of the present invention is to provide higher quality tubular goods at lower costs.

These and other objectives, features, and advantages of the present invention will become apparent from the drawings, the descriptions given herein, and the appended claims. However, it will be understood that the any listed objective and/or other objectives, features, and advantages of the invention are provided only as an aid in understanding aspects of the invention, and are not intended to limit the invention in any way, and therefore do not form a comprehensive or restrictive list of objectives, and/or features, and/or advantages of the invention.

Accordingly, the present invention may comprise a system for post weld conditioning of a weld in a tubular to reduce discontinuities that may be produced by working of the weld into a wall of the tubular. The system may comprise one or more elements such as, for instance, a first high energy source for producing the weld in the tubular. The tubular may be mounted for movement with respect to the first high energy source such that the weld forms an elongate bead. The elongate bead may be formed along the tubular so as to be parallel to the movement of the tubular when the tubular is moved with respect to the first high energy source. A second high energy source is provided and the tubular may also be mounted for movement with respect to the second high energy source. In a preferred embodiment, the first and second high energy sources are relatively fixed in position with respect to each other. The second high energy source may also be aligned with the first high energy source so as to be positioned for applying energy to the elongate bead for melting the elongate bead to thereby widen an upper portion of the elongate bead.

In one preferred embodiment, the first high energy source comprises a laser beam welder and/or the second high energy source comprises a TIG welder. The tubular may comprise a vessel for suitable for containing pressure or take on any other suitable shape.

One embodiment of the present invention may comprise a method with one or more steps such as, for instance, welding the lengthwise seam in the tubular to form an initial elongate bead comprising a crown portion with an initial width and extending radially outwardly of a surface of the tubular by an initial radial distance. Other steps may comprise subsequently melting the crown portion of the initial elongate bead to thereby form a conditioned elongate bead whereby the conditioned elongate bead comprises a conditioned width greater than the width of the initial elongate bead. In a preferred embodiment, the conditioned elongate bead extends outwardly from the surface of the tubular by a conditioned radial distance and the conditioned radial distance is preferably less than the initial radial distance.

In another embodiment of the invention, the method may comprise one or more steps such as producing an initial elongate bead by affixing an initial welding machine in position and moving a work piece to be welded with respect to the initial welding machine whereby the initial bead may have the crown portion with an initial width and extend radially outwardly of a surface of the tubular by an initial radial distance. Other steps may comprise producing a conditioned elongate bead by melting the crown portion of the initial elongate bead with a subsequent welding machine mounted in position to follow the initial elongate bead as the workpiece is moved. The conditioned elongate bead may preferably extend radially outwardly from the surface of the tubular by less than the initial radial distance.

### BRIEF DESCRIPTION OF DRAWINGS

For a further understanding of the nature and objects of the present invention, reference should be had to the following detailed description, taken in conjunction with the accompanying drawings, in which like elements may be given the same or analogous reference numbers and wherein:

FIG. 1 is a perspective view of a system for welding in accord with one possible embodiment of the present invention;

FIG. 2 is a cross-sectional view taken along lines 2-2 of FIG. 1;

FIG. 3 is an elevational view, partially in section, of a weld nugget produced in the seam of a tubular by high energy welding and the stress or flow lines in the tubular;

FIG. 3A is an enlarged view showing stress or flow lines from FIG. 3;

FIG. 4 is an elevational view, partially in section, of the crown of the weld nugget of FIG. 1 being worked into the pipe;

FIG. 4A is an enlarged view showing stress or flow lines from FIG. 4;

FIG. 5 is an elevational view, partially in section, of the crown of the weld nugget flush with the surface of the pipe and the stress risers created during shaping of the pipe in accord with the prior art;

FIG. 5A is an enlarged view showing stress or flow lines from FIG. 5;

FIG. 6 is an elevational view, partially in section, of a weld nugget as in FIG. 3;

FIG. 6A is an enlarged view showing stress or flow lines from FIG. 6;

FIG. 7 is an elevational view, partially in section, of the result of abrasion of the crown of the weld nugget in accord with the prior art;

FIG. 7A is an enlarged view showing stress or flow lines from FIG. 7;

FIG. 8 is an elevational view, partially in section, of the result of working the weld of FIG. 7 into the tubular wall;

FIG. 9 is an elevational view, partially in section, of the same weld nugget of FIG. 3 prior to a conditioning process in accord with one possible embodiment of the present invention;

FIG. 9A is an enlarged view showing stress or flow lines from FIG. 9;

FIG. 10 is an elevational view, partially in section, of the crown of the weld nugget with post weld treatment in accord with one possible embodiment of the present invention;

FIG. 10A is an enlarged view showing stress or flow lines from FIG. 10;

FIG. 11 is an elevational view, partially in section, of the weld after working of the pipe whereby the stress or flow lines remain substantially consistent in accord with one possible embodiment of the present invention;

FIG. 11A is an enlarged view showing stress or flow lines from FIG. 11;

FIG. 12 is an elevational view, in section, showing a work piece as the crown of the weld nugget undergoes post weld conditioning in accord with one possible embodiment of the present invention;

FIG. 12A is a sectional view along lines 12A-12A of FIG. 10 showing the work piece prior welding;

FIG. 12B is a sectional view along lines 10B-10B of FIG. 12 showing the work piece as initially welded;

FIG. 12C is a sectional view along lines 12C-12C of FIG. 12 showing the work piece surface being conditioned in accord with one possible embodiment of the present invention;

FIG. 12D is a sectional view along lines 12D-12D of FIG. 12 showing the work piece being worked by rolling;

FIG. 12D is a sectional view along lines 10E-10E of FIG. 12 showing the work piece after the weld is worked into the tubular wall in accord with one possible embodiment of the present invention.

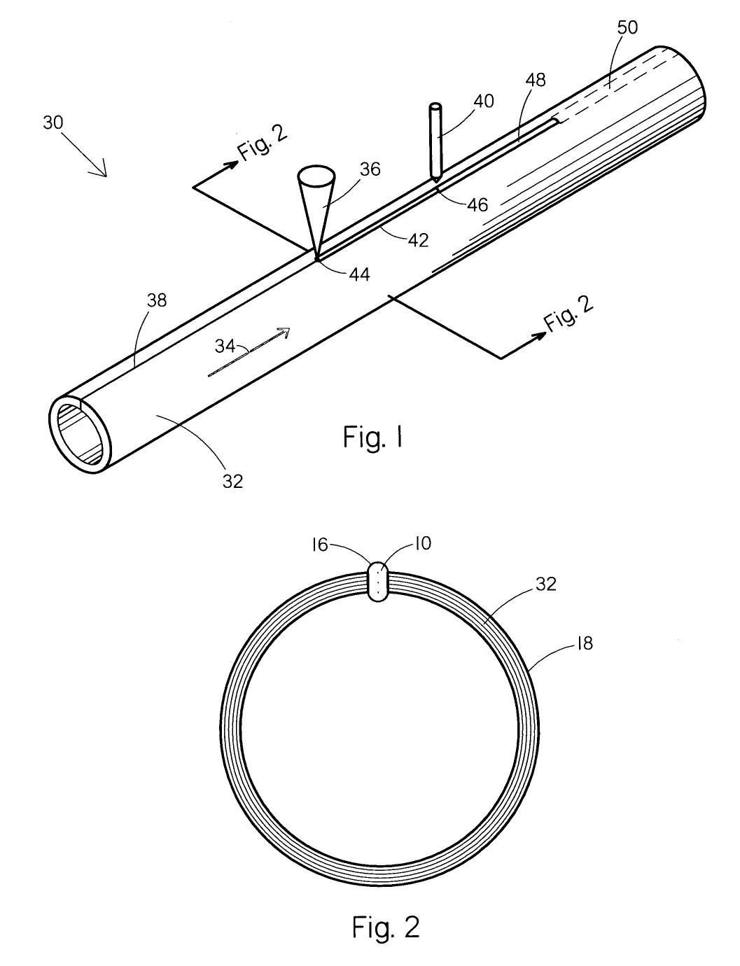

While the present invention will be described in connection with presently preferred embodiments, it will be understood that it is not intended to limit the invention to those embodiments. On the contrary, it is intended to cover all alternatives, modifications, and equivalents included within the spirit of the invention.

### GENERAL DESCRIPTION AND PREFERRED MODES FOR CARRYING OUT THE INVENTION

The present invention provides a novel approach to conditioning the weld bead without mechanical contact. The present invention reduces stresses in the weld that might cause fatigue as compared to prior art methods. Moreover, the weld produced as taught herein is as strong as or stronger than the wall of material surrounding the weld. Because no mechanical contact occurs, there is no need to repeatedly readjust the means utilized to remove the weld bead or nugget due to wear thereof. A preferred embodiment of the present invention is described hereinafter that may easily be implemented into existing manufacturing systems and may utilize relatively less expensive off-the-shelf technology. However, it will be understood that custom designed implementations may also be utilized to perform the method of the invention.

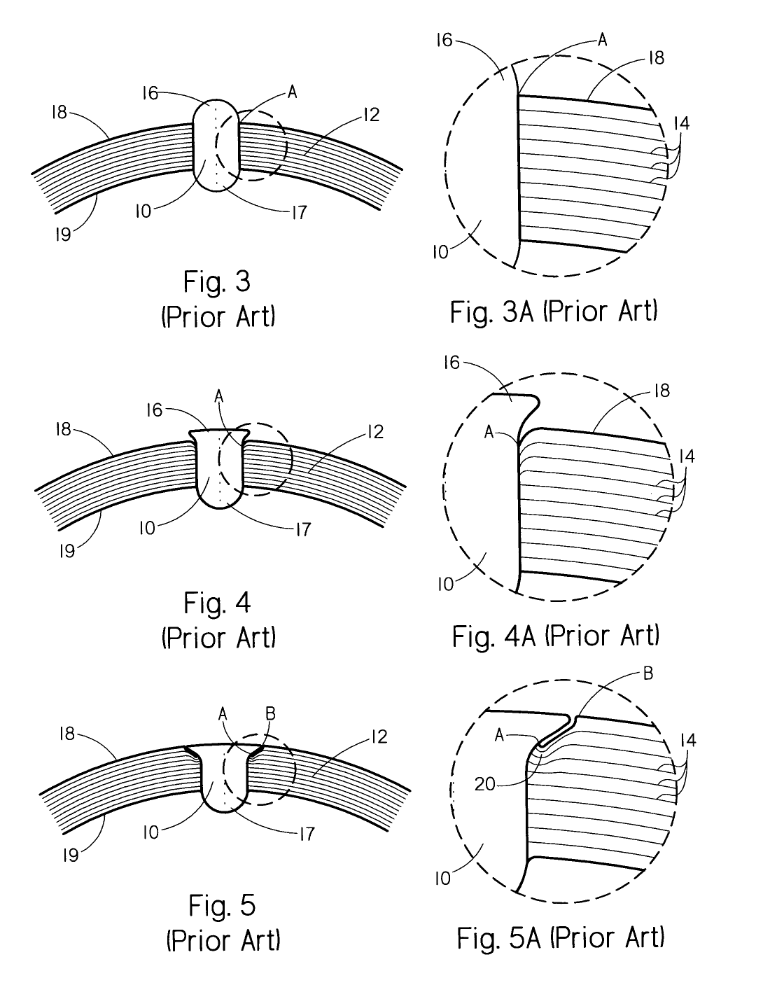

Now referring to the drawings, and more particularly to FIG. 3-FIG. 6, there are shown prior art methods for rolling the weld bead or nugget 10 into tubular 12. Stress or flow lines are indicated generally at 14 in enlarged views FIG. 3A-FIG. 6A. Nugget 10 includes a crown 16 that extends radially outwardly of surface 18 of tubular 12. Nugget 10 also typically includes a lower portion 17 that extends radially inwardly of an inner surface 19 of tubular 12. As weld bead or nugget 10 is worked into tubular 12, stress or flow lines 14 become sharply bent so that stresses applied to tubular 12 will result in non-uniform forces and tubular 12 will be more susceptible to fatigue failure and/or other types of failure.

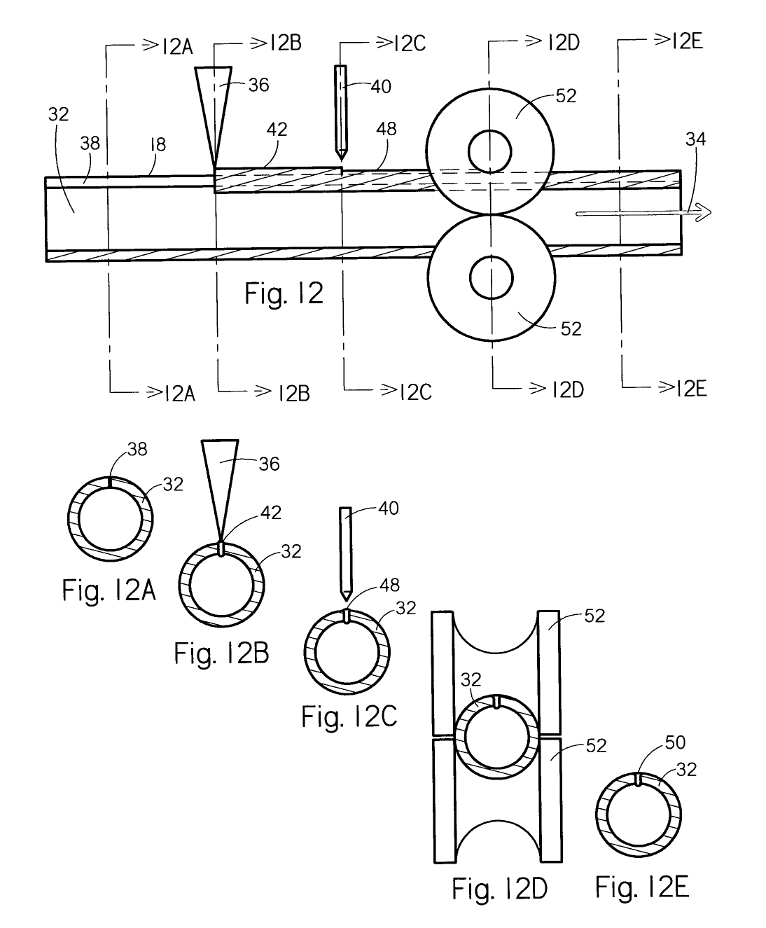

It is informative to follow point A on weld nugget 10 during this process. In FIG. 4, weld nugget 10 is partially rolled or worked into tubular 12 such as with rollers 52 of the type shown in FIG. 12. Crown 16 is flattened. Because weld nugget 10 is relatively hard as compared to pipe 12, point A moves radially inwardly and surface 18 of tubular 12 is bent inwardly adjacent to nugget 10 as shown in FIG. 4 when nugget 10 is compressed inwardly. After weld bead 10 is completely worked into tubular 12 as shown in FIG. 5, point A is moved further radially inwardly as indicated in FIG. 5. FIG. 5A shows an enlargement of FIG. 5 for clearer viewing. Material between point A and B are not welded together but simply pressed tightly together. This fold over between points A and B is very susceptible to becoming a crack initiator. Stress or flow lines 14 are altered adjacent to the heat effect boundary of nugget 10 in a manner largely perpendicular or highly angled with respect to surface as indicated at 20. Thus, stress risers may be formed along the length of the tubular so produced.

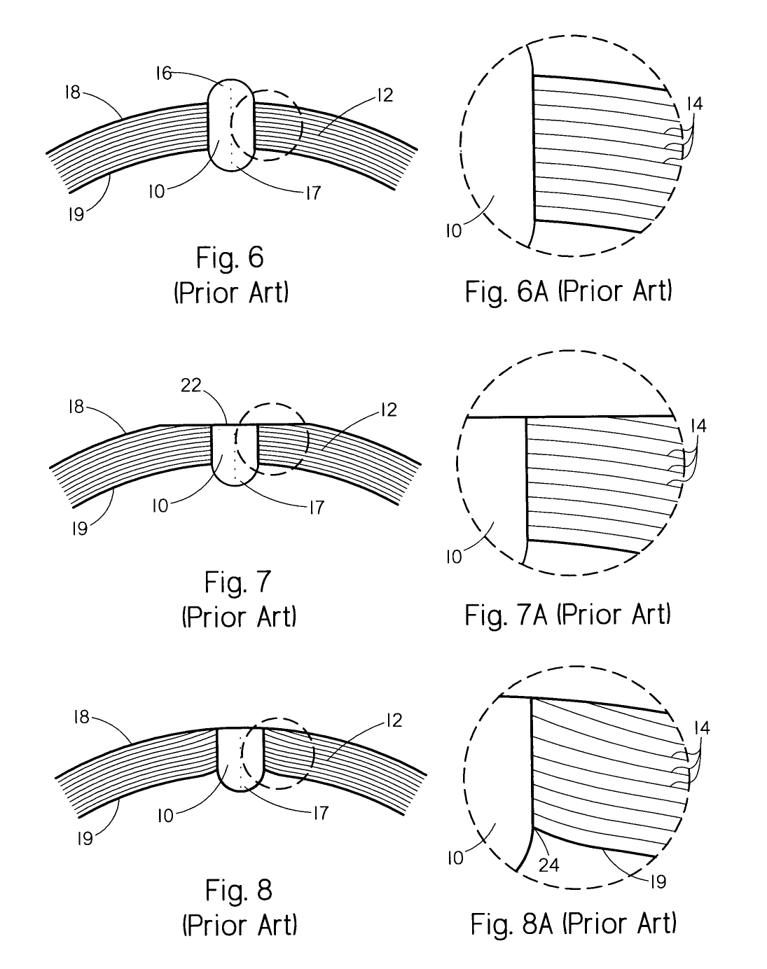

In FIG. 6-FIG. 8 the prior art method of removing crown 16 by abrasive means is illustrated and the consequences thereof. FIG. 6A-FIG. 8A are enlarged to better show the resulting flow or stress lines. FIG. 6 and FIG. 6A show the results after welding the seam of tubular 12 as discussed hereinbefore. FIG. 7 shows tubular 12 after abrasion removes crown 16 and typically also removes a portion of outer tubular wall 18 to produce flattened section 22. After working tubular 12 the result is shown in FIG. 8. In this case, nugget 10 is pushed radially outwardly thereby pushing inner tubular wall radially outwardly as well adjacent to nugget 10. Therefore, the tubular wall in the region indicated by numeral 24 is decreased in thickness thereby producing a weakened portion of tubular wall adjacent the weld which is more subject to failure. Stress or flow lines 14 are bent radially outwardly but not as pronounced as shown when nugget 10 is simply worked into the tubular wall as shown in FIG. 3-FIG. 5.

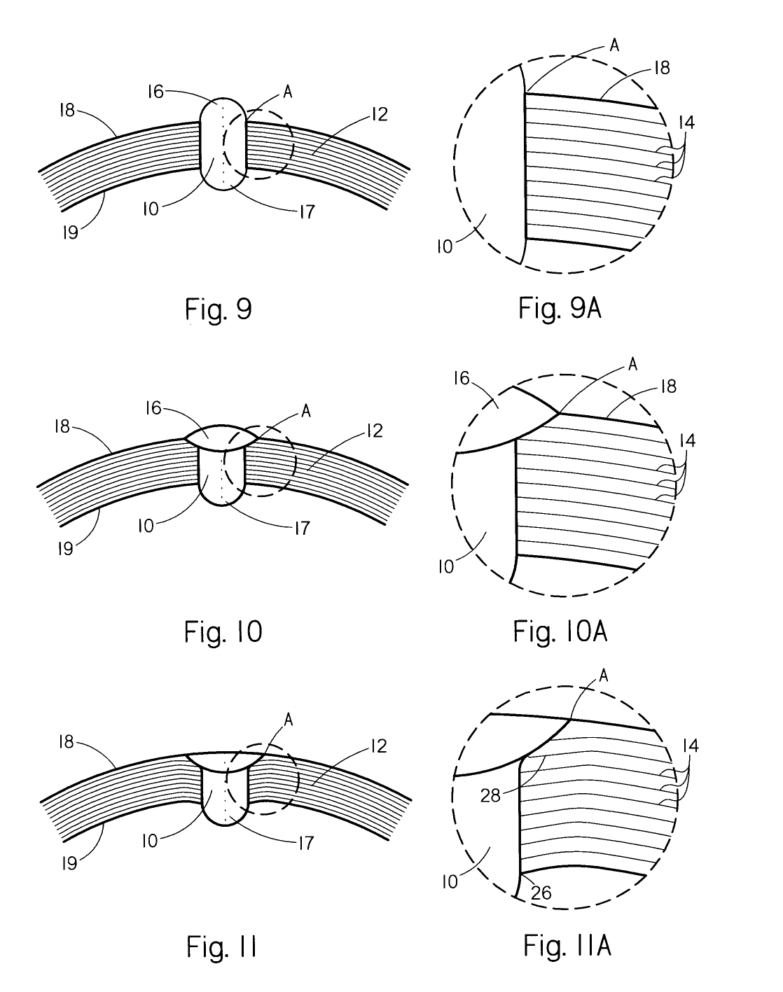

In FIG. 9-FIG. 11, nugget or bead 10 is conditioned in accord with a presently preferred embodiment of the present invention to thereby avoid creation of stress risers. FIG. 9A-FIG. 11A show enlargements of the flow or stress lines in the region adjacent nugget 10. FIG. 9 again shows the initial “as welded” condition which was shown previously in FIG. 3 and which may also be a starting point of the presently preferred process. FIG. 10 represents the bead condition after a post weld heating method is applied in accord with the present invention. As indicated, crown portion 16 of bead 10 is melted to provide a new heat effect area. The height of crown 16 is reduced and the thickness widened. Note that now point A effectively simply moves along surface 18 of tubular 10. Now when bead 10 is rolled or worked into tubular 12 the result of which is indicated in FIG. 11, the radially inwardly directed forces due to the working are spread over a wider area. So the stress or flow lines 14 after bead 10 are rolled into tubular 12 as shown in FIG. 11A remain substantially similar in comparison to the situation of FIG. 9A. Because no sharp changes are produced in stress or flow lines 14, stress risers are not formed that might fail due to fatigue. Moreover, there is no fold over crevice or unwelded area as shown in FIG. 5. In fact, the wall thickness may actually be increased by a small amount around bead 10 in the region indicated by numeral 26 resulting in a stronger weld strength and no decrease in rated tubular wall strength as occurred in the prior art method result shown in FIG. 8A.

FIG. 1 and FIG. 12 disclose presently preferred system 30 for implementing one embodiment of the present invention in the form of a continuous tubular manufacturing operation. In system 30 as shown in FIG. 1, tubular 32 is preferably moved in the direction of arrow 34 by any suitable tubular moving means known to those of skill in the art such as rollers or the like (not shown). Laser beam welding device 36 (or other high energy device such as electron beam, plasma arc, gas tungsten arc, or the like) is preferably fixed in position so that tubular 32 moves with respect thereto. If desired, various sensors (not shown) may be utilized to control or adjust the position of laser beam welder 36 with respect to tubular 32 and unwelded seam 38. Post welder 40 is also preferably relatively fixed in position so that tubular 32 also moves with respect thereto. Post welder 40 is preferably in a fixed position with respect to laser beam welder 36 and positioned downstream far enough away therefrom so that bead 42 produced by laser beam welder 36 has solidified by the time a corresponding point on the bead is moved thereto. Since bead 42 solidifies quickly, this offset distance may actually be quite close and/or may be adjusted to provide a desired temperature of the bead 42 as bead 42 cools after initial welding. Post welder 40 is also preferably a high energy welding device, and in a presently preferred embodiment is a TIG welder such as a gas tungsten arc welder. However, any suitable device, including a laser beam welder, that is preferably capable of precision uniform work may be utilized in accord with the present invention.

In operation, tubular 32 is moved in the direction of arrow 34. Laser beam welder 36 welds seam 38 at position 44 preferably utilizing keyholing techniques for deeper penetration. Bead 42 is produced and extends lengthwise along tubular 32 due to movement of tubular 32 in the direction of arrow 34. Bead 42 thereby seals the seam of tubular 32. In accord with the present invention, post welder or TIG 40 then melts the upper portion or crown of bead 42 at position 46 so that bead 42 is flattened out to form surface and subsurface conditioned bead 48, as shown in FIG. 11. Subsequent working of tubular 32 produces the weld final weld region 50.

FIG. 12 provides an elevational view, in cross-section, of the same process with additional cross-sections shown in FIG. 12A-FIG. 12E for the various stages of operation of this embodiment of the present invention. Therefore, at the position of sectional lines 12A-12A in FIG. 12, the initial construction of tubular 32 with unwelded seam 38 is indicated in FIG. 12 and in FIG. 12A. As indicated at sectional lines 10B-10B, laser beam welder 36 produces bead 42 to seal seam 38. As indicated, bead 42 extends radially outwardly with respect to surface 18 of tubular 32. Bead 42 also typically extends radially inwardly of the inner surface of tubular 32. As indicated at sectional lines 10C-10C, post welder or TIG 40 remelts the upper portion of bead 42 to flatten it out such that the radial height is reduced to produce conditioned bead 48 which has an increased width and decreased height. Rollers such as rollers 52 are utilized for working tubular 32 as indicated at 12D-12D. The final weld area 50 has the same height as tubular surface 18. The width of weld area 50 is further increased and the height is decreased with respect to conditioned bead 48. In accord with the present invention, the subsequent working of tubular 32 utilizing rollers 52 or other working means results in a strong weld without producing stress risers or cracks for the reasons discussed hereinbefore.

The present invention has many advantages over the prior art, some of which are summarized hereinafter or discussed hereinafter. The welding technique of the present invention enables a manufacturer to roll the conditioned bead into the parent metal without creating stress risers or crevices. The present invention eliminates the need to mechanically remove the bead/weld flash. Because the present invention provides for non-contact conditioning, the components utilized for conditioning are not subject to wear. The weld stresses are redistributed, as compared to the prior art, from perpendicular at some points to a comparatively much reduced angle. There is a better cosmetic finish to pipes or tubes produced using the present invention. The present invention reduces or eliminates weld fit-up issues such as fill-out under a cut. When used with pressure vessels, the avoidance of stress risers reduces failures caused by fatigue. The technique maintains maximum tubular wall thickness and weld thickness. The process reduces the gradient of grain structure change and therefore reduces the chance of creating a shear plane. The invention may be built utilizing relatively low cost off-the-shelf technology. The present invention is easily integrated into existing systems.

The present invention enhances defect detection techniques by reducing the potential noise measured by such techniques that arises in prior art pipes due to rolled-in beads or crevices. The smooth surface condition eliminates end forming longitudinal effects. Thus, not only does the present invention improve the quality of pipe in the region of the weld but also results in an overall improved product. The present invention permits maximum laser power/speed combinations to produce deep penetration of laser beam welder 36 and a flat crown 48 after post welder or TIG 40. Moreover, by utilizing the techniques of the present invention, materials that may not otherwise be readily laser beam welded may be welded utilizing the combined welding techniques taught herein. By monitoring the voltages involved in laser welding, the present invention may also be utilized to detect/repair/verify the quality of the weld. For instance, the TIG voltage feedback circuit, can be utilized to detect whether there has been a variation in the distance between TIG 40 and the top of the bead. If the feedback voltage drops, this can be produced by a high weld bead surface or relative closeness to TIG 40. Likewise, if the feedback voltage (and/or current) increases, this can be produced by a low weld bead surface. Thus, by monitoring the feedback voltage (and/or current) the weld quality can be determined. Variations in weld bead surface can then be corrected by any suitable means as deemed desirable. Other means such as proximity sensors, acoustic, sonic, light beam, or other means can also be utilized to verify a consistent height and width for weld 48.

There is no hazardous waste to dispose. Nor are there any safety, health, or cleanliness concerns that are commonly associated with prior art bead removal techniques. Thus, the present invention is anticipated to reduce and/or eliminate the high costs of prior art bead removal techniques including the installation costs, maintenance costs, operational costs, and costs of health related systems and/or results. Thus, the overall effect of the present invention is lower costs and higher quality.

While tubular goods have been the focus of the present invention, other types of work pieces and materials may also benefit from use of the welding techniques taught in accord with the present invention.

The foregoing disclosure and description of the invention is therefore illustrative and explanatory of a presently preferred embodiment of the invention and variations thereof, and it will be appreciated by those skilled in the art, that various changes in the design, manufacture, layout, organization, order of operation, means of operation, equipment structures and location, methodology, the use of mechanical equivalents, as well as in the details of the illustrated construction or combinations of features of the various elements may be made without departing from the spirit of the invention. For instance, instead of two welding machines, other combinations of welding machines including additional welding machines or combined multiple position welding machines could be utilized to perform the method of the present invention. As well, the drawings are intended to describe the concepts of the invention so that the presently preferred embodiments of the invention will be plainly disclosed to one of skill in the art but are not intended to be manufacturing level drawings or renditions of final products and may include simplified conceptual views. Thus, various changes and alternatives may be utilized that remain within the spirit of the invention. Because many varying and different embodiments may be made within the scope of the inventive concept(s) herein taught, and because many modifications may be made in the embodiment herein detailed in accordance with the descriptive requirements of the law, it is to be understood that the details herein are to be interpreted as illustrative of a presently preferred embodiment and not in a limiting sense.

What is claimed is:

1. A system for post weld conditioning of a weld, said system comprising:
a first high energy source for producing said weld in a tubular, said tubular being mounted for movement with respect to said first high energy source such that said weld forms an elongate bead, said elongate bead being formed along said tubular so as to be parallel to said movement of said tubular when said tubular is moved with respect to said first high energy source; and
a second high energy source, said tubular being mounted for movement with respect to said second high energy source, said second high energy source being aligned with said first high energy source so as to be positioned for applying energy to said elongate bead to thereby melt an upper portion of said elongate bead.

2. The system of claim 1, wherein said first high energy source comprises a laser beam welder.

3. The system of claim 1, wherein said second high energy source comprises a TIG welder.

4. The system of claim 1, wherein said tubular comprises a vessel suitable for containing pressure.

5. The system of claim 1, wherein said first high energy source and said second high energy source are fixed in position with respect to each other.

6. A method for post weld conditioning in a tubular prior to working of said tubular, said method comprising:
automatically welding a lengthwise seam in said tubular to form an initial elongate bead, said initial elongate bead having a crown portion with an initial width and extending radially outwardly of a surface of said tubular by an initial radial distance;
subsequently automatically melting said crown portion of said initial elongate bead to thereby form a conditioned elongate bead whereby said conditioned elongate bead comprises a conditioned width greater than said initial width of said initial elongate bead.

7. The method of claim 6, wherein said conditioned elongate bead extends outwardly from said surface of said tubular by a conditioned radial distance, said conditioned radial distance being less than said initial radial distance.

8. The method of claim 6, permitting said initial elongate bead to solidify prior to said subsequent melting of said crown portion of said initial elongate bead.

9. The method of claim 6, further comprising utilizing a laser beam welder to form said initial elongate bead.

10. The method of claim 9, further comprising moving said tubular with respect to said laser beam welder.

11. The method of claim 6, further comprising utilizing a TIG welder for melting said crown portion.

12. The method of claim 6, further comprising working said tubular to compress said conditioned elongate bead whereby a weld zone is formed having a final width greater than said conditioned width.

13. A method for post weld conditioning, said method comprising:
producing an initial elongate bead by affixing an initial welding machine in position and moving a work piece to be welded with respect to said initial welding machine, said initial bead having a crown portion with an initial width, said crown extending radially outwardly of a surface of said tubular by an initial radial distance; and
producing a conditioned elongate bead by melting said crown portion of said initial elongate bead with a subsequent welding machine mounted in position to follow said initial elongate bead as said workpiece is moved, said conditioned elongate bead extending outwardly from said surface of said tubular by a conditioned radial distance, said conditioned radial distance being less than said initial radial distance.

14. The method of claim 13, wherein said conditioned elongate bead comprises a conditioned width greater than said initial width of said initial elongate bead.

15. The method of claim 14, further comprising working said tubular to compress said conditioned elongate bead whereby a weld zone is formed having a final width greater than said conditioned width.

16. The method of claim 13, permitting said initial elongate bead to solidify prior to said subsequent melting of said crown portion of said initial elongate bead.

17. The method of claim 13, wherein said initial welding machine comprises a laser beam welder.

18. The method of claim 13, wherein said work piece comprises a tubular.

19. The method of claim 13, wherein said subsequent welding machine comprises a TIG welder for melting said crown.

20. The method of claim 13, further comprising affixing said initial welding machine and said subsequent welding machine with respect to each other.
